(19) United States
(12) Patent Application Publication
(10) Pub. No.: US 2013/0250778 A1
(43) Pub. Date: Sep. 26, 2013

(54) METHOD AND APPARATUS FOR DISTRIBUTED COMMUNICATIONS

(71) Applicants: Gilles Charbit, Farnborough (GB); Matti Kullervo Jokimies, Salo (FI)

(72) Inventors: Gilles Charbit, Farnborough (GB); Matti Kullervo Jokimies, Salo (FI)

(73) Assignee: RENESAS MOBILE CORPORATION, Tokyo (JP)

(21) Appl. No.: 13/431,323

(22) Filed: Mar. 27, 2012

(30) Foreign Application Priority Data
Mar. 21, 2012 (GB) 1204904.5

(51) Int. Cl. H04W 72/04; H04W 24/00

(52) U.S. Cl. 370/248; 370/329

(57) ABSTRACT

A method, apparatus and computer program product are therefore provided according to an example embodiment to distributed communications. In this regard, a method includes causing an actual channel and a shadow channel to be configured to carry information for a logical channel. In some example embodiments, the logical channel is configured for at least one QCI class. The method of this embodiment may also include configuring an actual channel on a secondary link and a shadow channel on a primary link. The method of this embodiment may also include causing the shadow channel and the actual channel to be swapped such that the actual channel is configured on the primary link and the shadow channel is configured on the secondary link in an instance in which it is determined that the secondary link is no longer available.

### CROSS-REFERENCE TO RELATED APPLICATIONS

This application is based upon and claims the benefit of priority from the prior UK Patent Application No. 1204904.5, filed on Mar. 21, 2012, the entire contents of which are incorporated herein by reference.

### TECHNOLOGICAL FIELD

Embodiments of the present invention relate generally to communications system technology and, more particularly, to carrier aggregation.

### BACKGROUND

Intelligent transportation systems (ITS) are configured to automate interactions between vehicles in order to achieve greater levels of safety, security and efficiency. For example, an ITS may enable a mobile terminal on an emergency vehicle to notify surrounding vehicles and/or upcoming traffic of its approach. Advantageously the notification may cause an alert and may even attempt to slow nearby vehicles to allow for the safe passage of the emergency vehicle. Other embodiments of an ITS may include setting variable speed limits, reporting traffic flow and/or the like.

In order to provide wireless access in vehicular environments, a Wireless Access Vehicular Environment (WAVE) system architecture was developed. A WAVE system consists of road side units (RSUs) usually positioned along roads and mobile terminals (e.g., on board units or OBUs) mounted in vehicles The RSUs and mobile terminals may form WAVE basic service sets (WBSSs) connected to the Wide Area Network (WAN) via an appropriate portal. Such a portal may be implemented via cable linking the RSU and the WAN, but this may, for example, add significantly to cost of implementing an ITS system. Another version of a WAVE system may be implemented wirelessly over an ITS band. Over time, the use of the wireless band has proven, for example, to starve an ITS- Dedicated Short Range Communications (DSRC) system of frequency resources. The ITS-DSRC is customarily deployed over 75 MHz of bandwidth in a relatively high-frequency band around 5.9 GHz in 10-20 MHz channel bandwidth, and therefore may not be suited for potentially long transmission range due to path loss. Additionally, increasing transmission power of the RSU-WAN link to account for the transmission range may lead to significant interference issues for the RSU-mobile terminal link. Other current wireless solutions, such as those solutions used in current cellular networks are generally not suitable for an ITS environment due to the potential speed and high mobility of a mobile terminal as well as the generally small size of some RSU cells.

### BRIEF SUMMARY

In one embodiment, a method is provided that comprises causing an actual channel and a shadow channel to be configured to carry information for a logical channel. In some example embodiments, the logical channel is configured for at least one Quality of Service (QoS) Class Identifier (QCI) class. The method of this embodiment may also include configuring an actual channel on a secondary link and a shadow channel on a primary link. The method of this embodiment may also include causing the shadow channel and the actual channel to be swapped such that the actual channel is configured on the primary link and the shadow channel is configured on the secondary link in an instance in which it is determined that the secondary link is no longer available. Advantageously and according to various example embodiments disclosed herein, the most favorable channel for a particular QCI may be re-allocated and/or swapped between a primary link and a secondary link. Further additional signaling is minimal according to some example embodiments; because there is no need for signaling when a link is changed.

In another embodiment, an apparatus is provided that includes at least one processor and at least one memory including computer program code with the at least one memory and the computer program code being configured, with the at least one processor, to cause the apparatus to at least cause an actual channel and a shadow channel to be configured to carry information for a logical channel. In some example embodiments, the logical channel is configured for at least one QCI class. The at least one memory and computer program code may also be configured to, with the at least one processor, cause the apparatus to configure an actual channel on a secondary link and a shadow channel on a primary link. The at least one memory and computer program code may also be configured to, with the at least one processor, cause the apparatus to cause the shadow channel and the actual channel to be swapped such that the actual channel is configured on the primary link and the shadow channel is configured on the secondary link in an instance in which it is determined that the secondary link is no longer available.

In the further embodiment, a computer program product may be provided that includes at least one non-transitory computer-readable storage medium having computer-readable program instructions stored therein with the computer-readable program instructions including program instructions configured to cause an actual channel and a shadow channel to be configured to carry information for a logical channel. In some example embodiments, the logical channel is configured for at least one QCI class. The computer-readable program instructions may also include program instructions configured to configure an actual channel on a secondary link and a shadow channel on a primary link. The computer-readable program instructions may also include program instructions configured to cause the shadow channel and the actual channel to be swapped such that the actual channel is configured on the primary link and the shadow channel is configured on the secondary link in an instance in which it is determined that the secondary link is no longer available.

In yet another embodiment, an apparatus is provided that includes means for causing an actual channel and a shadow channel to be configured to carry information for a logical channel. In some example embodiments, the logical channel is configured for at least one QCI class. The apparatus of this embodiment may also include means for configuring an actual channel on a secondary link and a shadow channel on a primary link. The apparatus of this embodiment may also include means for causing the shadow channel and the actual channel to be swapped such that the actual channel is configured on the primary link and the shadow channel is configured on the secondary link in an instance in which it is determined that the secondary link is no longer available.

In one embodiment, a method is provided that comprises receiving network traffic via an actual channel over the secondary link. In some example embodiments, an actual channel and the shadow channel are configured to carry information for a logical channel and the logical channel is configured for at least one QCI class. The method of this embodiment may also include determining whether a secondary link is available. The method of this embodiment may also include receiving the network traffic via an actual channel over the primary link. In some example embodiments, the shadow channel and the actual channel are swapped such that the actual channel is configured on the primary link and the shadow channel is configured on the secondary link in an instance in which it is determined that the secondary link is no longer available.

In another embodiment, an apparatus is provided that includes at least one processor and at least one memory including computer program code with the at least one memory and the computer program code being configured, with the at least one processor, to cause the apparatus to at least receive network traffic via an actual channel over the secondary link. In some example embodiments, an actual channel and the shadow channel are configured to carry information for a logical channel and the logical channel is configured for at least one QCI class. The at least one memory and computer program code may also be configured to, with the at least one processor, cause the apparatus to determine whether a secondary link is available. The at least one memory and computer program code may also be configured to, with the at least one processor, cause the apparatus to receive the network traffic via an actual channel over the primary link. In some example embodiments, the shadow channel and the actual channel are swapped such that the actual channel is configured on the primary link and the shadow channel is configured on the secondary link in an instance in which it is determined that the secondary link is no longer available.

In the further embodiment, a computer program product may be provided that includes at least one non-transitory computer-readable storage medium having computer-readable program instructions stored therein with the computer-readable program instructions including program instructions configured to receive network traffic via an actual channel over the secondary link. In some example embodiments, an actual channel and the shadow channel are configured to carry information for a logical channel and the logical channel is configured for at least one QCI class. The computer-readable program instructions may also include program instructions configured to determine whether a secondary link is available. The computer-network readable program instructions may also include program instructions configured to receive the traffic via an actual channel over the primary link. In some example embodiments, the shadow channel and the actual channel are swapped such that the actual channel is configured on the primary link and the shadow channel is configured on the secondary link in an instance in which it is determined that the secondary link is no longer available.

In yet another embodiment, an apparatus is provided that includes means for receiving network traffic via an actual channel over the secondary link. In some example embodiments, an actual channel and the shadow channel are configured to carry information for a logical channel and the logical channel is configured for at least one QCI class. The apparatus of this embodiment may also include means for determining whether a secondary link is available. The apparatus of this embodiment may also include means for receiving the network traffic via an actual channel over the primary link. In some example embodiments, the shadow channel and the actual channel are swapped such that the actual channel is configured on the primary link and the shadow channel is configured on the secondary link in an instance in which it is determined that the secondary link is no longer available.

### BRIEF DESCRIPTION OF THE DRAWINGS

Having thus described the example embodiments of the invention in general terms, reference will now be made to the accompanying drawings, which are not necessarily drawn to scale, and wherein:

FIG. 1 is a schematic representation of an example ITS that may benefit from an embodiment of the present invention;

FIG. 2 is a block diagram of an example apparatus that may be embodied by an example mobile terminal, RSU and/or access point in accordance with one embodiment of the present invention;

FIG. 3 is an overview diagram illustrating example carrier aggregation according to an embodiment of the present invention;

FIG. 4a-4b illustrates example implementation of a actual channel and a shadow channel in accordance with one embodiment of the present invention;

FIG. 5 is a flow chart illustrating operations performed by an example access point in accordance with one embodiment of the present invention; and

FIG. 6 is a flow chart illustrating operations performed by an example mobile terminal in accordance with one embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

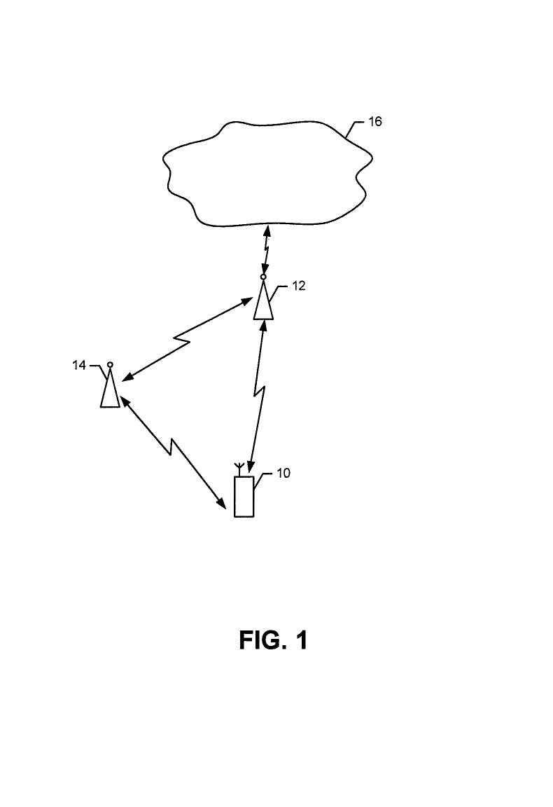

Although the method, apparatus and computer program product may be implemented in a variety of different systems, one example of such a system is shown in FIG. 1, which includes a first communication device (e.g., mobile terminal 10) that is capable of communication via a access point 12, such as a base station, a macro cell, a Node B, an evolved Node B (eNB) or other access point or via an RSU 14 with a network 16 (e.g., a core network). While the network may be configured in accordance with long term evolution (LTE) or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

In an embodiment, an RSU 14 may be embodied as a transparent relay, without, for example, a cell ID, the RSU 14 may be configured to perform an initial cell access as a special mobile terminal to a macro-cell access point within coverage area. For example and as is discussed in LTE release-10, a specified Type 1 non-transparent relay, such as the RSU 14, may achieve downlink synchronization and perform initial cell access procedure over the air as a special mobile terminal.

In some example embodiments, the mobile terminal 10 may be in data communications with the access point 12, such that a communication that is transmitted by the access point 12 is received by the mobile terminal 10 and vice versa. In such cases the communications link between the mobile terminal 10 and the access point 12 is referred to as the primary link. In some example embodiments the mobile terminal 10 may be in communications with the RSU 14, such that a communication that is transmitted by the RSU 14 is received by the mobile terminal 10 and vice versa. In such cases, the RSU 14 is in communications with the access point 12. The communications link between the mobile terminal 10 and RSU 14 is referred to as the secondary link.

In some example embodiments, the primary link is ubiquitous, therefore the primary link is typically used for, but is not limited to voice calls (quality of service (QoS) channel indicator (QCI)=1), conversational video (QCI=2), IMS signaling (QCI=5) real-time gaming (QCI=3) and radio resource control (RRC) signaling. In some example embodiments, the QCI classes, which could utilize Semi-Persistent Scheduling (SPS) and thus require semi-permanent reservations (e.g., voice calls would be configured for the primary link. The secondary link may be used for all other QCI classes. In instances in which the secondary link is unavailable (e.g. RSU 14 not in communications range with mobile terminal 10) network traffic and or network communications may be configured to be transmitted over the primary link.

The network 16 may include a collection of various different nodes, devices or functions that may be in communication with each other via corresponding wired and/or wireless interfaces. For example, the network may include one or more cells, including access point 12 and which may serve a respective coverage area. The access point could 12 be, for example, part of one or more cellular or mobile networks or public land mobile networks (PLMNs). In turn, other devices such as processing devices (e.g., personal computers, server computers or the like) may be coupled to the mobile terminal 10 and/or other communication devices via the network.

A communication device, such as the mobile terminal 10 (also known as user equipment (UE) and/or an onboard unit (OBU)), may be in communication with other communication devices or other devices via the access point 12, the RSU 14 and, in turn, the network 16. In some cases, the communication device may include an antenna for transmitting signals to and for receiving signals from an access point 12 and/or the RSU 14.

In some example embodiments, the mobile terminal 10 may be a mobile communication device such as, for example, a vehicle-mounted transceiver unit, a mobile telephone, portable digital assistant (PDA), pager, laptop computer, or any of numerous other hand held or portable communication devices, computation devices, content generation devices, content consumption devices, or combinations thereof. As such, the mobile terminal 10 may include one or more processors that may define a processing system or processing circuitry either alone or in combination with one or more memories. The processing circuitry may utilize instructions stored in the memory to cause the mobile terminal 10 to operate in a particular way or execute specific functionality when the instructions are executed by the one or more processors. The mobile terminal 10 may also include communication circuitry and corresponding hardware/software to enable communication with other devices and/or the network 16.

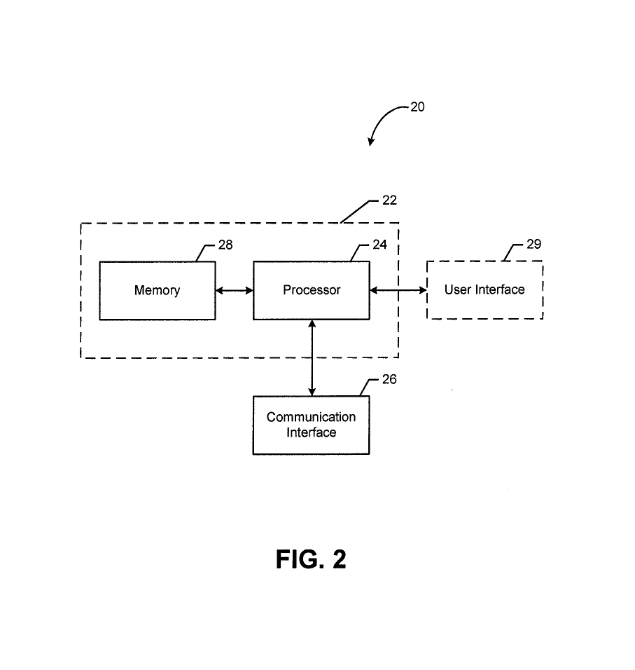

In one embodiment, for example, the mobile terminal 10, the access point 12 and/or the RSU 14 may be embodied as or otherwise include an apparatus 20 as generically represented by the block diagram of FIG. 2. While the apparatus 20 may be employed, for example, by a mobile terminal 10, an access point 12 or an RSU 14, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. As is described herein, the processing circuitry may also be referred to as a processing system. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26 and, in some cases, a user interface 29. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 29 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. The apparatus 20 need not always include a user interface. For example, in instances in which the apparatus is embodied as an access point 12 and/or an RSU 14, the apparatus may not include a user interface. As such, the user interface is shown in dashed lines in FIG. 2.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 16 and/or any other device or module in communication with the processing circuitry 22, such as between the mobile terminal 10, the access point 12 and the RSU 14. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

A method, apparatus and computer program product for some example embodiments of the present invention is configured to provide carrier aggregation by distributing network traffic over a primary link and a secondary link. In some example embodiments the network traffic may be arranged in logical channels based on QoS characteristics. For example, the network traffic may be distributed based on a QCI class. QCI classes are explained in 3GPP TS 23.203 v11.4.0. 3GPP TS 23.203 v11.4.0 is incorporated by reference in its entirety herein. In some example embodiments, the network traffic may be divided into logical channels on the radio link control (RLC) layer. For example, at the RLC layer, the network traffic may be divided such that the RLC packet data units (PDU) relating to different QCI classes are delivered to different logical channels (e.g. Dedicated Traffic Channels (DTCH)).

However, in instances in which a secondary link is configured to transport one or more logical channels, there may be an instance in which there is frequent configuring/reconfiguring of that secondary link. As is described herein, the secondary link is configured, for example, in instances in which an RSU 14 is in communications range with a mobile terminal 10. For example, there may be frequent configuring/reconfiguring of a connection between an RSU 14 and a mobile terminal 10 in the case of an ITS with a vehicle based mobile terminal 10. Although not limited to a vehicle based mobile terminal 10, the vehicle based example shows the potential for rapid configuring/reconfiguring of the secondary link based on the speed of the mobile terminal 10.

To avoid configuring and re-configuring data bearers for each addition/removal of a secondary link, in some example embodiments, the configurations for the logical channels may be doubled. For example, a logical channel may be doubled by creating an actual channel and a shadow channel that are configured to operate on either the primary link and the secondary link. An actual channel is configured to perform as the logical channel for the QCI with air interface resources assigned. A shadow channel may be also be configured but would not be configured with any resources, however the shadow channel would be configured such that it could have resources allocated in an instance in which the secondary link is removed or the active link is somehow removed. Due to the flexible structure of Evolved Universal Terrestrial Radio Access Network (E-UTRAN) medium access control (MAC) and L1, no permanent resource reservation needs to be done for the shadow channel. The actual channel and the shadow channel may then be configured to be swapped in instances in which the secondary link is either added or removed.

For example, in an instance in which the secondary link is removed, the shadow channel on the primary link may then be configured to become the actual channel for a QCI class and is further configured to use the same buffer and data bearers as the actual channel utilized over the secondary link. As a result of the secondary link being removed, the actual channel on the secondary link becomes the shadow channel for the QCI class without any resources reserved as those resources have now been assigned to the actual channel on the primary link. In an instance in which the secondary link is then once again added (e,g an RSU is in range and the mobile terminal 10 attaches), the shadow channel and the actual channel may once again be swapped.

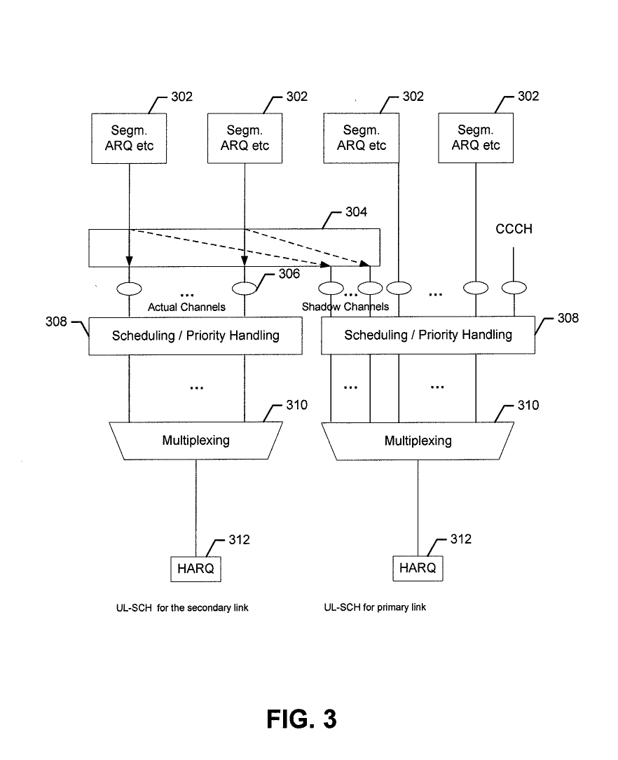

FIG. 3 is an overview diagram illustrating example carrier aggregation according to some example embodiments of the present invention. As is shown in blocks 302, the network traffic may perform segmentation of the RLC PDUs, which is described with reference to 3GPP TS 36.300 v11.0.0. 3GPP TS 36.300 v11.0.0 is incorporated by reference in its entirety herein. At block 304, the network traffic may be divided, such that the PDUs are delivered to different logical channels 306 based on QCI class. Thus in block 304, a shadow channel and an actual channel is configured for each QCI class resulting in a double-configuration for each logical channel that may operate on the secondary link.

In some example embodiments, in order to implement the actual channel and the shadow channel, the access point such as by the processing circuitry 22, may cause an information element “LogicalChannelConfig” to be doubled, thus resulting in the actual channel and the shadow channel. The actual channel and the shadow channel are then assigned a single bearer identity (e.g. for all bearers that may be carried over the secondary link). Switching between the actual channel and the shadow channel is based on lower layer decisions (e.g., based on existing secondary cell, such as RSU 14, activation/deactivation). As an additional mechanism, in some example embodiments, it may be possible to swap shadow and actual channels by explicit RRC signaling, e.g., when resources are removed from relay node. Extra RLC Acknowledged Mode (AM) buffer resources may not need to be reserved for a shadow channel. In an instance in which the shadow and actual channels are swapped, the buffered PDUs may be kept in the buffer and sent over the new actual channel once the swap is complete. In some example embodiments, the buffer is common for both the actual channel and the shadow channel because the buffering is accomplished before the RLC PDUs are allocated to logical channels.

In some example embodiments and in an instance in which both the primary and the secondary links are in use, the actual and shadow channels are arranged as shown in FIG. 3. In an instance in which only the primary link is in use, the actual channels would be configured to operate on the primary link with a shadow channel configured for the secondary link in the instance in which it becomes available. In some example embodiments, the actual and shadow channels are scheduled and prioritized at block 308 and then multiplexed at block 310. Hybrid Automatic Repeat Request HARQ is performed at block 312 for each of the uplink (UL)-Synchronization Channel (SCH) for the secondary link and UL-SCH for the primary link.

In some example embodiments, the double-configuration is visible only on parts of medium access control (MAC) and RLC layers, while upper layers see only one channel per bearer, and lower layers see a carrier aggregation (CA) operation. Therefore, for example, no unnecessary bearer resource reservations are conducted, and packet data convergence protocol (PDCP) functionalities may not be impacted. The double-configuration may be visible on the RRC layer as configuration parameters. RRC may not be required in some embodiments for the swapping of actual and shadow channels.

In some example embodiments, and as is described herein QCI class may be used to determine a carrier, e.g. the primary control channel (PCC) or secondary control channel (SCC). However, also other, non-carrier aggregation based allocations are possible. Alternatively or additionally carrier aggregation is permitted within the primary and/or secondary link.

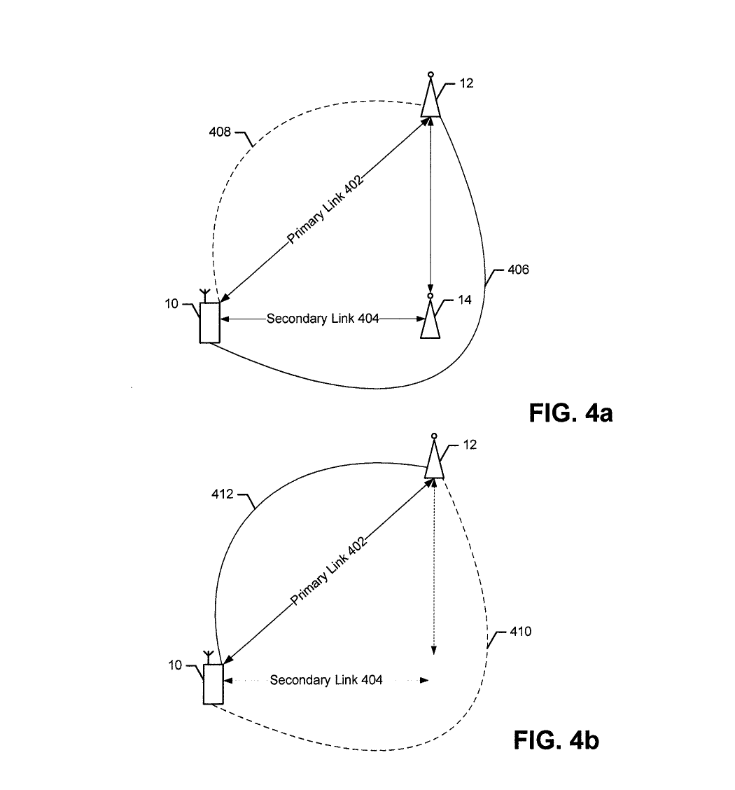

FIGS. 4a-4b illustrate an example implementation of an actual channel and a shadow channel in accordance with one embodiment of the present invention. As is shown in FIGS. 4a and 4b, a mobile terminal 10 may be in communications with an access point 12 via a primary link 402. As is shown in FIG. 4a the mobile terminal 10 is connected to a RSU 14 via a secondary link 404. In FIG. 4a, an actual channel 406 is configured to be transmitted by the access point 12, via the RSU 14, and is received by the mobile terminal 10 and vice versa. For example, the actual channel 406 may be configured for buffered streaming (QCI=6). A shadow channel 408 is configured over the primary link 402 between the mobile terminal 10 and the access point 12. The shadow channel 408 may also, for example, be configured without air interface resources reserved and may, for example, be configured as the shadow channel for buffered streaming (QCI=6).

FIG. 4b shows an instance in which the secondary link is removed. The secondary link may be removed, for example, in an instance in which an RSU 14 is no longer in range or available. As is shown by shadow channel 410, in an instance in which the RSU 14 is removed, the secondary link now carries the shadow channel and the primary link carries the actual channel 412. For example, the primary link comprises the actual channel for buffered streaming (QCI=6).

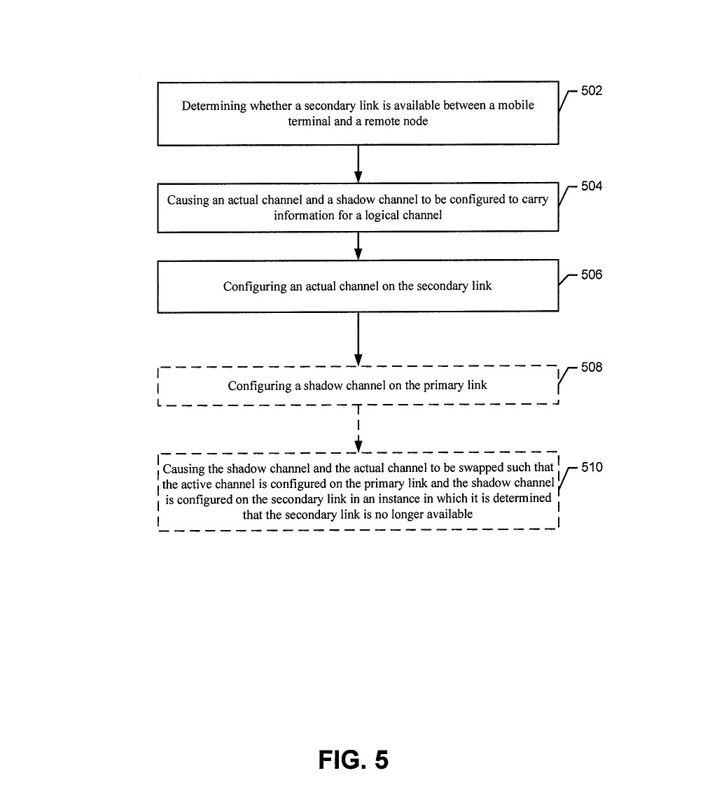

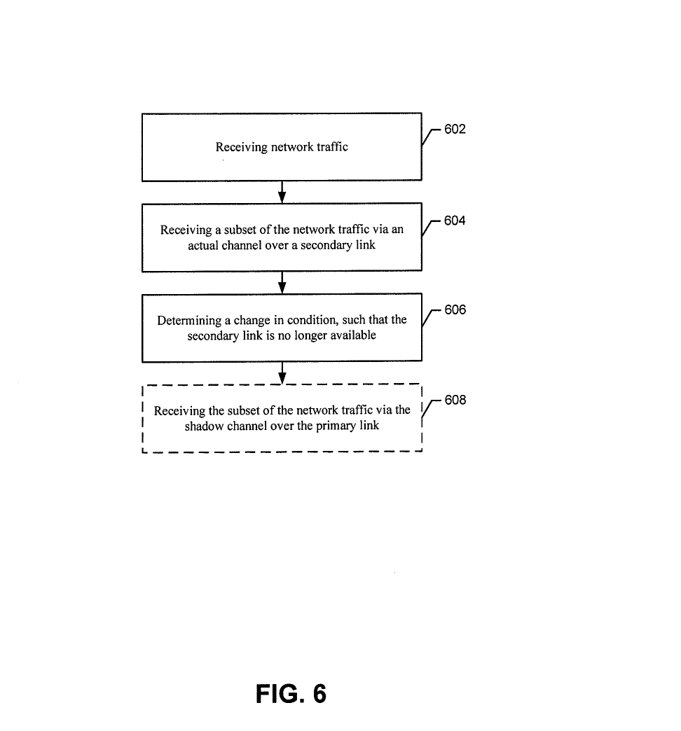

FIGS. 5-6 illustrate example operations performed by a method, apparatus and computer program product, such as apparatus 20 of FIG. 2 in accordance with one embodiment of the present invention are illustrated. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 28 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 5-6, when executed, convert a computer or processing circuitry into a particular machine configured to perform an example embodiment of the present invention. Accordingly, the operations of FIGS. 5-6 define an algorithm for configuring a computer or processing circuitry 22, e.g., processor, to perform an example embodiment. In some cases, a general purpose computer may be provided with an instance of the processor which performs the algorithm of FIGS. 5-6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included (some examples of which are shown in dashed lines in FIG. 4). It should be appreciated that each of the modifications, optional additions or amplifications below may be included with the operations above either alone or in combination with any others among the features described herein.

FIG. 5 is a flow chart illustrating operations performed by an example access point in accordance with one embodiment of the present invention. As is shown in operation 502, the apparatus 20 embodied, for example, by an access point 12, may include means, such as the processing circuitry 22, the processor 24, or the like, for determining whether a secondary communications link is available between a mobile terminal and a remote node. In some example embodiments, the primary link is configured for a transmission between an access point and a mobile terminal and the secondary link is configured for a transmission between an access point and a mobile terminal via a remote node. In some example embodiments, an access point 12, may include means, such as the processing circuitry 22, the processor 24, or the like, for causing the network traffic distribution over the primary link and the secondary link to be determined in a radio link control layer prior to medium access control multiplexing. In some example embodiments, the network traffic is distributed over the primary link and the secondary link based on a QCI.

As is shown in operation 504, the apparatus 20 embodied, for example, by an access point 12, may include means, such as the processing circuitry 22, the processor 24, the communications interface 26 or the like, for causing an actual channel and a shadow channel to be configured to carry information for a logical channel. As is shown in operation 506, the apparatus 20 embodied, for example, by an access point 12, may include means, such as the processing circuitry 22, the processor 24, the communications interface 26 or the like, for configuring an actual channel on the secondary link. In some example embodiments, the actual channel is a logical channel that is configured for at least one QCI class. As is shown in operation 508, the apparatus 20 embodied, for example, by an access point 12, may include means, such as the processing circuitry 22, the processor 24, the communications interface 26 or the like, for configuring a shadow channel on the primary link. In some example embodiments, the shadow channel is a duplicate of the actual channel and thus the actual channel and the shadow channel may be swapped.

As is shown in operation 510, the apparatus 20 embodied, for example, by an access point 12, may include means, such as the processing circuitry 22, the processor 24, the communications interface 26 or the like, for causing the shadow channel and the actual channel to be swapped such that the actual channel is configured on the primary link and the shadow channel is configured on the secondary link in an instance in which it is determined that the secondary link is no longer available. The apparatus 20 embodied, for example, by an access point 12, may include means, such as the processing circuitry 22, the processor 24, or the like, for causing packet data units (PDU) in a buffer to be sent over the actual channel on the primary link in an instance in which it is it is determined that the secondary link is no longer available. In some example embodiments, the actual channel and the shadow channel are assigned a single bearer identity and may share a common buffer.

FIG. 6 is a flow chart illustrating operations performed by an example mobile terminal in accordance with one embodiment of the present invention. As shown in operation 602, the apparatus 20 embodied, for example, by a mobile terminal 10, may include means, such as the processing circuitry 22, the processor 24, the communications interface 26 or the like, for receiving network traffic. In some example embodiments, the network traffic is distributed over at least one of a primary link and a secondary link. The primary link is configured for a transmission between an access point and a mobile terminal and the secondary link is configured for a transmission between an access point and a mobile terminal via an RSU.

As shown in operation 604, the apparatus 20 embodied, for example, by a mobile terminal 10, may include means, such as the processing circuitry 22, the processor 24, the communications interface 26 or the like, for receiving a subset of the network traffic via an actual channel over a secondary link. In some example embodiments, the actual channel is a logical channel that is arranged to provide at least one QCI. The shadow channel is a duplicate of the actual channel and is configured on the primary link. The shadow channel is created for each actual channel configured for transmission on the secondary link and the shadow channel may be configured without a resource allocation, such as an air interface allocation.

As shown in operation 606, the apparatus 20 embodied, for example, by a mobile terminal 10, may include means, such as the processing circuitry 22, the processor 24 or the like, for determining a change in condition, such that the secondary link is no longer available. The mobile terminal 10, may include means, such as the processing circuitry 22, the processor 24, the communications interface 26 or the like, for receiving PDUs from a buffer that is sent over the actual channel on the primary link in an instance in which the secondary link is no longer available, the actual channel and the shadow channel are assigned a single bearer identity and share a buffer.

As shown in operation 608, the apparatus 20 embodied, for example, by a mobile terminal 10, may include means, such as the processing circuitry 22, the processor 24, the communications interface 26 or the like, for receiving the network traffic via an actual channel over the primary link. In some example embodiments, the shadow channel is activated and becomes an actual channel on the primary link in an instance in which the secondary link is no longer available.

Advantageously, the apparatus, method and computer program product as described herein also enables, for example, slow-moving mobile terminals (at pedestrian speeds and in indoor applications) can also benefit from the systems and methods described herein. For example, in office environment, where high-frequency band radio nodes are used for capacity, the links may change several times even within a few meters (or even in stationary use, when people move in front of hotspot antennas). These kind of configurations are probable in the future networks, where bulk of the traffic is handled by relays, while the QoS sensitive traffic (primarily voice calls) are handled by macro cells.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
causing an actual channel and a shadow channel to be configured to carry information for a logical channel, wherein the logical channel is configured for at least one Quality of Service (QoS) Class Identifier (QCI) class;
causing an actual channel to be configured on a secondary link and a shadow channel on a primary link; and
causing the shadow channel and the actual channel to be swapped such that the actual channel is configured on the primary link and the shadow channel is configured on the secondary link in an instance in which it is determined that the secondary link is no longer available.

2. A method according to claim 1, further comprising:
determining whether a secondary communications link is available between a mobile terminal and a remote node; and
causing network traffic to be distributed over a primary link and a secondary link in an instance in which the secondary link is arranged for communications.

3. A method according to claim 1, further comprising:
causing the shadow channel and the actual channel to be swapped such that the actual channel is configured on the primary link and the shadow channel is configured on the secondary link in an instance in which it is determined that the secondary link is available.

4. A method according to claim 1, wherein the primary link is configured for a transmission between an access point and a mobile terminal and the secondary link is configured for a transmission between the access point and a mobile terminal via a remote node.

5. A method according to claim 1, further comprising:
causing the shadow channel to be created on the primary link for each actual channel configured for transmission on the secondary link.

6. A method according to claim 1, wherein the shadow channel is configured without a resource allocation.

7. A method according to claim 1, further comprising:
causing the shadow channel to be activated using radio resource control signaling.

8. A method according to claim 1 wherein the actual channel and the shadow channel are assigned a single bearer identity.

9. A method according to claim 1 further comprising:
causing packet data units (PDU) in a buffer to be sent over the actual channel in an instance in which it is it is determined that the secondary link is no longer available, wherein the buffer is common for the actual channel and the shadow channel.

10. A method according to claim 1 further comprising:
causing network traffic to be distributed over the primary link and the secondary link is determined in a radio link control layer prior to medium access control multiplexing.

11. A method according to claim 1 wherein a logical channel is defined based on a QCI class.

12. A method comprising:
receiving network traffic via an actual channel over a secondary link, wherein an actual channel and a shadow channel are configured to carry information for a logical channel and the logical channel is configured for at least one Quality of Service (QoS) Class Identifier (QCI) class;
determining whether a secondary link is available; and
receiving network traffic via an actual channel over a primary link, wherein the shadow channel and the actual channel are swapped such that the actual channel is configured on the primary link and the shadow channel is configured on the secondary link in an instance in which it is determined that the secondary link is no longer available.

13. A method according to claim 12 further comprising:
receiving network traffic via an actual channel over the secondary link, wherein the shadow channel and the actual channel are swapped such that the actual channel is configured on the secondary link and the shadow channel is configured on the primary link in an instance in which it is determined that the secondary link is available

14. A method according to claim 12, wherein the primary link is configured for a transmission between an access point and a mobile terminal.

15. A method according to claim 12, wherein the secondary link is configured for a transmission between an access point and a mobile terminal via a remote node.

16. A method according to claim 12 wherein the actual channel and the shadow channel are assigned a single bearer identity.

17. A method according to claim 12 further comprising:
receiving packet data units (PDU) from a buffer to be sent over the actual channel in an instance in which the secondary link is no longer available, the buffer being common for the actual channel and the shadow channel.

18. A method according to claim 12 wherein a logical channel is defined based on a QCI class.

19. An apparatus comprising:
at least one processor; and
at least one memory including computer program code, the at least one memory and the computer program code configured to, with the at least one processor, cause the apparatus to at least:
receive network traffic via an actual channel over a secondary link, wherein an actual channel and a shadow channel are configured to carry information for a logical channel and the logical channel is configured for at least one Quality of Service (QoS) Class Identifier (QCI) class;
determine whether a secondary link is available; and
receive network traffic via an actual channel over a primary link, wherein the shadow channel and the actual channel are swapped such that the actual channel is configured on the primary link and the shadow channel is configured on the secondary link in an instance in which it is determined that the secondary link is no longer available.

20. An apparatus according to claim 19 wherein the at least one memory including the computer program code is further configured to, with the at least one processor, cause the apparatus to:
receive network traffic via an actual channel over the secondary link, wherein the shadow channel and the actual channel are swapped such that the actual channel is configured on the secondary link and the shadow channel is configured on the primary link in an instance in which it is determined that the secondary link is available
